(19) United States
(12) Patent Application Publication
(10) Pub. No.: US 2024/0144208 A1
(43) Pub. Date: May 2, 2024

(54) Continuously Available Distributed Cloud Database-Based Transaction System

(71) Applicant: Bank of America Corporation, Charlotte, NC (US)

(72) Inventor: Vishal Patangia, West Hills, CA (US)

(21) Appl. No.: 17/977,900

(22) Filed: Oct. 31, 2022

(51) Int. Cl. G06Q 20/10; G06Q 20/08

(52) U.S. Cl. CPC G06Q 20/10; G06Q 20/085

(57) ABSTRACT

Various aspects of the disclosure relate to a continuously available distributed payment transaction system. Multiple payment transaction applications initiate payment transactions in a high-volume enterprise network. Payment transaction information is communicated to a regionalized payment data store, where the payment information is mirrored on each region to ensure consistent data availability and access. Payment transaction data is converted to a standardized format to be replicated across all regions. Data inquiries are performed via application programming interface function calls to the centralized data store to allow data to be consumed by client applications to complete a payment transaction.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to efficiently, effectively, securely, and uniformly manage its computer systems, and particularly manage how internal computer systems exchange information with external computer systems in providing and/or supporting different products and services offered by the organization.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

Aspects of the disclosure relate to computer hardware and software. In particular, one or more aspects of the disclosure generally relate to computer hardware and software for deploying and implementing a continuously available distributed payments transaction computing system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes providing a remote-hosted (e.g., cloud-based) multi-regional distributed data repository providing real time and/or near real-time read/write capabilities for payment transaction information.

Often, financial institutions or other enterprise organizations may offer customers the opportunity to use a plurality of payment methods via different products and/or services offered by the particular enterprise organization. For example, a banking institution may offer a number (over 10, over 20, and the like) payment products to consumers for their use to execute a payment transaction. In some cases, the payment functions may be supported, either partially or entirely, by vendors. Due to heterogeneous payment processing systems, associated information (e.g., payment data) may be federated in various record systems. The various record system may contain history (e.g., a full history, a limited history) and/or current payment transaction processing information. Due to the complexities of the increasing number of payment methodologies and/or their associated systems, multiple challenges may be experienced when managing payment data and/or provisioning. For example, transaction processing and transaction inquiry may only be serviced by a particular system (e.g., a system of record). Additionally, adoption of digital payments and usage growth of digital payment systems are increasingly taxing current systems, requiring scaling of each existing system at a massive rate. New payment products and migration of existing payment functions from vendor-based computing systems to internally managed computing systems increases data scaling requirements of the enterprise computing system. Further, the multiple payment methods and systems cause data to be duplicated multiple times from each system of record due to lack of a consolidated Payment Data store (ODS). Often, data provisioning may be used to gather data from multiple computing systems to generate aggregate views for internal and/or customer service applications. However, this data provisioning requires additional integration with multiple computing systems. Additional data provisioning performed for reporting and/or analytics purposes often requires integration with multiple payment data stores, however lack of a standard data model to represents data across various products increases processing times or requires additional hardware to handle the data conversion requirements. Further online access to payment systems and desired real-time inquiry is limited due to the difficulty of unlocking data values to ensure the federated data is available to the real-time inquiry-based systems. In some cases, a streaming platform and/or service may be integrated into the system to facilitate data transfer to a cloud based payment ODS.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for deploying and implementing a continuously available distributed payments transaction computing system, in accordance with one or more aspects described herein;

FIG. 1B shows an illustrative computing platform enabled for deploying and implementing a continuously available distributed payments transaction computing system, in accordance with one or more aspects described herein;

FIG. 2 shows illustrative system and method for deploying and implementing a continuously available distributed payments transaction computing system in accordance with one or more aspects described herein; and

FIG. 3 show an illustrative use of the continuously available distributed payments transaction computing system, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Remote hosting of a centralized or regionalized payments ODS, allows for the remote hosting system such as a cloud service hosting system to be leveraged to provide a fully managed data repository as a service. Further, the payments ODS may be implemented as a distributed data store that may be geographically replicated and, therefore, continuously available for read and write access across geographical regions. Further, the remote architecture allows for automatically scaling of computing resources for data ingestion and/or data enquiry to improve processing times, latency issues and to improve data throughput.

In an illustrative example, a distributed data store may be implemented on a remote hosting platform (e.g., a cloud computing platform) to hold payment transaction information for payment transactions processed through multiple computing systems of an enterprise organization (e.g., a financial institution, a bank, and the like). The distributed data store may be accessible and/or replicated in multiple regional data centers and/or hosting platforms, where an additional data store may also be stored centrally within a data center within the enterprise computing network to ensure continual real-time access to the payments transaction information, even when a server, host, or entire hosting platform is incapacitated or otherwise inaccessible.

Data ingestion to this payments data repository may be implemented as an asynchronous process collecting data from various computing systems across the enterprise network, where the asynchronous process may operate in real-time to allow for real-time access and/or storage capabilities of the payments data store. Because the payments data repository may include a unique data accessible and active across multiple datacenters, the payments transaction data management process provides a continuous capability for reading and/or writing payments transaction data throughout the enterprise computing network. Further, a payment data model may be structured similar to one or more standardized data formats (e.g., an international standards organization (ISO) 20022 format), such that all different types of Payments transactions (e.g., electronic wire transfer transactions, direct consumer electronic person to person (P2P) transactions, electronic account to account transfer transactions, electronic bill payment transactions, and the like) may be commonly represented within a same single data store. As such, the multi-regional payment transaction data repository provides a highly scalable solution to meet requirements to facilitate data storage of payment transactions and/or requirements to perform payment transaction inquiries of past, current, and future payment transaction computing systems.

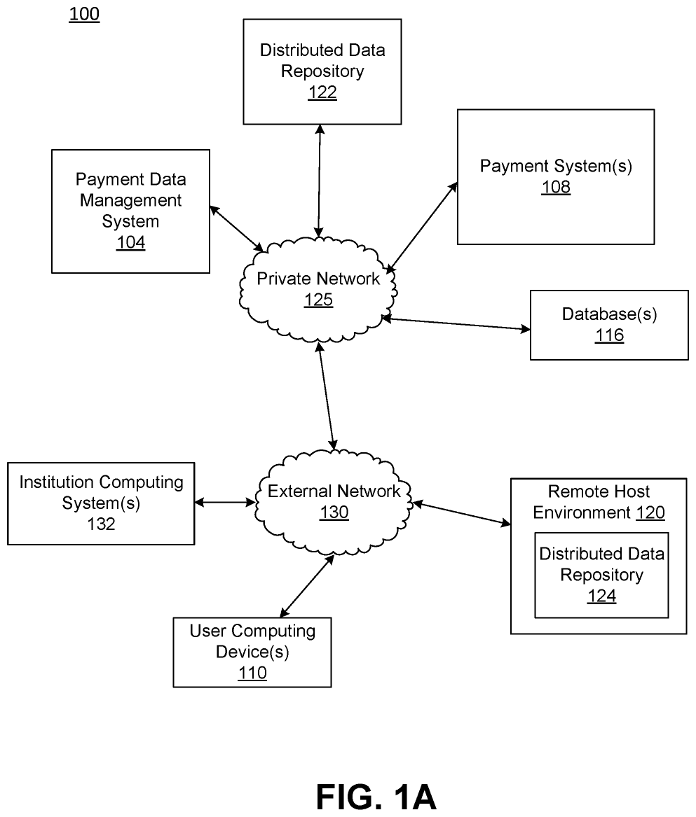

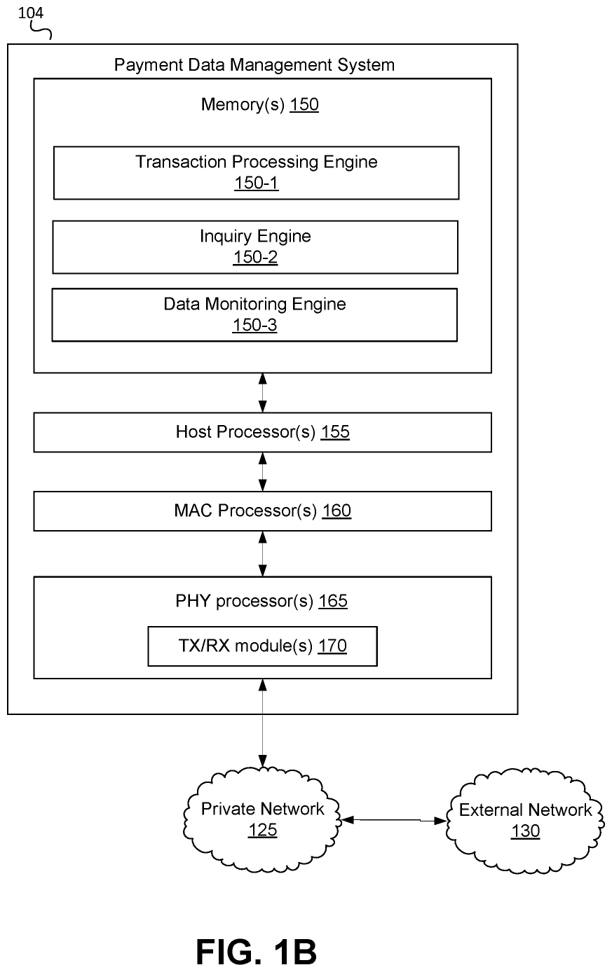

FIG. 1A shows an illustrative computing environment 100 for payment data management, in accordance with one or more arrangements. The computing environment 100 may comprise one or more devices (e.g., computer systems, communication devices, and the like). The computing environment 100 may comprise, for example, a payment data management system 104, one or more application systems and/or payment systems 108, a distributed data repository 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system, such as the one or more institution computing systems 132, a remote host environment 120 within which at least a portion of a distributed data repository 124 may be implemented, and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the payment data management system 104 implemented as a distinct system, components of the payment data management system 104 may be integrated into separate computing systems.

The payment data management system 104 may comprise one or more computing devices and/or other computer components (e.g., processors, memories, communication interfaces) configured to perform one or more functions as described herein. Further details associated with the architecture of the payment data management system 104 are described with reference to FIG. 1B.

The application systems and/or the payment systems 108 and/or the distributed data repository 122 may comprise one or more computing devices and/or other computer components (e.g., processors, memories, communication interfaces). In addition, the application systems and/or the payment systems 108 and/or the distributed data repository 122 may be configured to host, execute, and/or otherwise provide one or more enterprise applications. In some cases, the application systems and/or the payment systems 108 may host one or more services configured facilitate operations requested through one or more API calls, such as data retrieval and/or initiating processing of specified functionality. In some cases, the application systems and/or the payment systems 108 may provide services to a user so that the user may initiate one or more payment methods via their computing device (e.g., the user computing device 110). In some cases, the distributed data repository 122 and/or 124 may be configured to communicate with one or more of the application systems and/or the payment systems 108 such as via direct communications and/or API function calls and the services. In an arrangement where the private network 125 is associated with a financial institution (e.g., a bank), the application systems and/or the payment systems 108 may be configured, for example, to host, execute, and/or otherwise provide one or more transaction processing programs, such as an online banking application, fund transfer applications, and/or other programs associated with the financial institution. The distributed data repository 122 and/or 124 and/or the application systems and/or the payment systems 108 may comprise various servers and/or databases that store and/or otherwise maintain account information, such as financial account information including account balances, transaction history, account owner information, and/or other information. In addition, the distributed data repository 122 and/or 124 and/or the application systems and/or the payment systems 108 may process and/or otherwise execute transactions on specific accounts based on commands and/or other information received from other computer systems comprising the computing environment 100. In some cases, one or more of the distributed data repository 122 and/or 124 and/or the application systems and/or the payment systems 108 may be configured, for example, to host, execute, and/or otherwise provide one or more transaction processing programs, such as electronic fund transfer applications, online loan processing applications, and/or other programs associated with the financial institution.

The application systems and/or the payment systems 108 may be one or more host devices (e.g., a workstation, a server, and the like) or mobile computing devices (e.g., smartphone, tablet). In addition, an application systems and/or the payment systems 108 may be linked to and/or operated by a specific enterprise user (who may, for example, be an employee or other affiliate of the enterprise organization) who may have administrative privileges to perform various operations within the private network 125. In some cases, the application systems and/or the payment systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The institution computing systems 132 may comprise one or more computing devices and/or other computer components (e.g., processors, memories, communication interfaces). The institution computing systems 132 may be configured, for example, to host, execute, and/or otherwise provide one or more transaction processing programs, such as goods ordering applications, electronic fund transfer applications, online loan processing applications, and/or other programs associated with processing electronic payment transactions and/or otherwise providing a product or service to a user. With reference to the example where the institution computing systems 132 is for processing an electronic exchange of goods and/or services. The institution computing systems 132 may be associated with a specific goods purchasing activity, such as purchasing a vehicle, transferring title of real estate may perform communicate with one or more other platforms within the institution computing systems 132. In some cases, the institution computing systems 132 may integrate API calls to request data, initiate functionality, or otherwise communicate with the one or more application systems and/or payment systems 108, such as via the services. For example, the services may be configured to facilitate data communications (e.g., data gathering functions, data writing functions, and the like) between the institution computing systems 132 and the one or more application systems and/or payment systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by Payment Data Management System 104. For example, the database(s) 116 may store code corresponding to data ingestion, API code of an API to facilitate data requests from the distributed data repository 122 and/or 124, data conversion functions to manage data conversion from a data format used by the one or more application systems and/or payment systems 108, and the like. In an arrangement, the database(s) 116 may be used for other purposes as described herein. In some cases, the institution computing systems 132 may write data or read data to the database(s) 116 via the services. The distributed data repository 122 and/or the distributed data repository 124 may comprise a portion of portions of a continuously available payments data repository that may store payment transaction information from each of a plurality of payment processing systems 108 in a common format. In some cases, data requests may be formatted from the common data format into a format associated with the requesting application or process via a specific API call. In some cases, legacy programs may use API calls written to operate similarly to legacy communication methods to convert from the common data format of the distributed data repository into a legacy data format. In some cases, new application systems and/or payment systems 108, or new versions of existing applications and/or services, may incorporate new function calls that are capable of leveraging the common data format and/or additional information stored in the distributed data repository that were previously unavailable in the legacy data repository and/or data formats.

In some cases, a remote hosting environment (e.g., a cloud computing environment) may be used to provide a regionalized distributed data repository 124, such that the data stored in the distributed data repository 124 is continuously accessible to processes and/or applications that consume and/or provide the data. In some cases, application systems and/or payment systems 108 and/or the institution computing systems 132 may provide and/or request data from the distributed data repository 124 from a portion of the distributed data repository corresponding to an associated geographic region associated with the application systems and/or payment systems 108 and/or the institution computing systems 132. In some cases, each regionalized copy of the distributed data repository 124 may be a complete replicated copy of the whole distributed data repository. In some cases, the distributed data repository 122 may be distributed data resp

In one or more arrangements, the payment data management system 104, the application systems and/or payment systems 108, the distributed data repository 122, the remote host environment 120, the user devices 110, the institution computing systems 132, and/or the other devices/systems in the computing environment 100 may be any type of computing device capable of receiving input via a user interface, and communicating the received input to one or more other computing devices in the computing environment 100. For example, the payment data management system 104, the application systems and/or payment systems 108, the distributed data repository 122, the remote host environment 120, the user devices 110, the institution computing systems 132, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the payment data management system 104, the application systems and/or payment systems 108, the distributed data repository 122, the remote host environment 120, the user devices 110, the institution computing systems 132, and/or the other devices/systems in the computing environment 100 may, in some instances, be and/or comprise special-purpose computing devices configured to perform specific functions.

FIG. 1B shows an illustrative payment data management system 104 in accordance with one or more examples described herein. The payment data management system 104 may be a stand-alone device and/or may at least be partial integrated with another computing system and may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The payment data management system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the payment data management system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the payment data management system 104 may be configured to execute machine readable instructions stored in memory 150. The memory 150 may comprise (i) one or more program modules/engines having instructions that when executed by the one or more processors cause the payment data management system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the payment data management system 104 and/or by different computing devices that may form and/or otherwise make up the payment data management system 104. For example, the memory 150 may have, store, and/or comprise a transaction processing engine 150-1, an inquiry engine 150-2, a data monitoring engine 150-3 and/or the like. The transaction processing engine 150-1 may have instructions that direct and/or cause the payment data management system 104 to perform one or more operations associated with processing payment transaction information from multiple applications and/or services providing electronic payment functionality and causing the payment transaction information to be stored in the regionalized continuously available payment data repository in a common format. The inquiry engine 150-2 may have instructions that may cause the payment data management system 104 to provide data access functionality via one or more API functions, such as to request data stored in a common data format of the regionalized continuously available payment data repository, and to provide output in a format capable of being processed by the calling system, whether in a legacy data format or a common data format. The data monitoring engine 150-3 may have instructions that may cause the payment data management system 104 to provide alerts and/or reporting information corresponding to the health of the distributed data repository 122 and/or 124, communications between calling applications and/or services of the institution computing systems 132, the application systems and/or payment systems 108, a health of the remote host environment 120, data use metrics, network metrics, latency information, data repository replication information, data conversion metrics and/or errors, data access error information, and/or the like.

While FIG. 1A illustrates the payment data management system 104, the application system and/or payment systems 108, and/or the distributed data repository 122, as being separate elements connected in the private network 125, in one or more other arrangements, functions of one or more of the above may be integrated in a single device/network of devices. For example, elements in the payment data management system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the distributed data repository and/or the application systems and/or the payment systems 108.

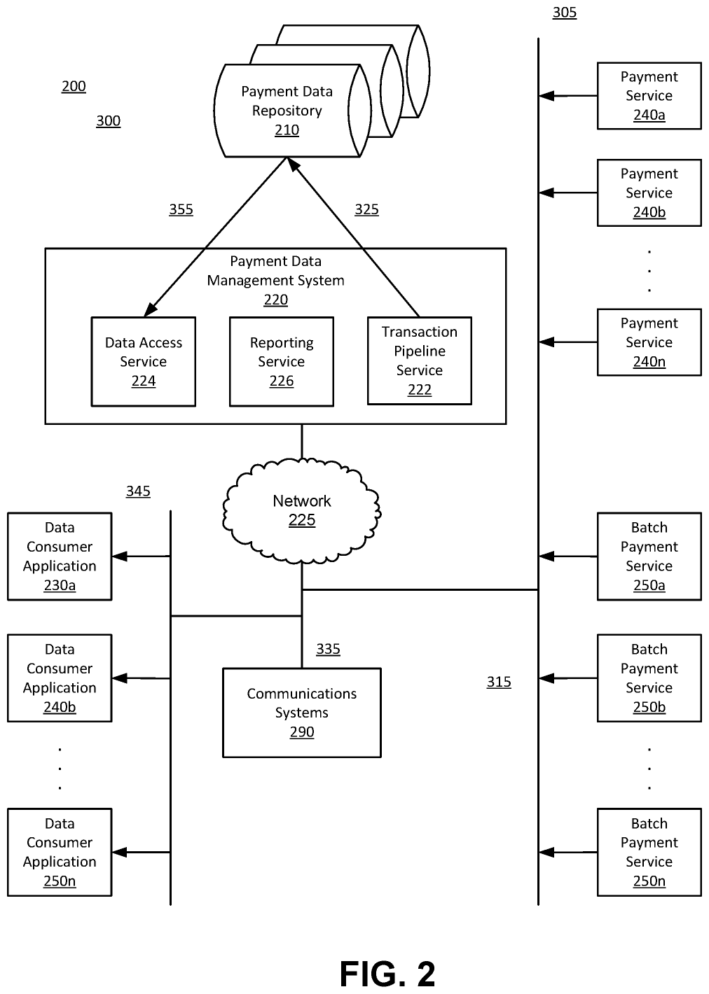

FIG. 2 shows illustrative system 200 and method 300 for deploying and implementing a continuously available distributed payments transaction computing system in accordance with one or more aspects described herein. The illustrative system may include one or more payment service applications performing electronic payment transactions via a network 225 (e.g., an enterprise organization network, the internet, and the like). The payment service applications may initiate individual payment transactions (e.g., the payment services 240a-n, and the like) or may communicate multiple payment transactions via batch processing (e.g., the batch payment services 250a-n and the like), such as at 315.

The payment services 240a-n and/or the batch payment services 250a-n may communicate payment transaction information to the multi-regional payment data repository 210 via a transaction pipeline service of a payment data management system 220. In some cases, the payment transaction information may be communicated in a standardized payment transaction format for direct storage in the payment data repository 210. In some cases, one or more of the payment services 240a-n and/or the batch payment services 250a-n may communicate payment transaction information in a legacy format, such that the transaction pipeline service 222 may initiate a data conversion process when storing the payment transaction information in the payment data repository 210, at 325. At 345, one or more data consumer applications 230a, some of which may be aspects of a payment service 240a-n and/or a batch payment service 250a, may request or otherwise consume payment transaction information stored in the payment data repository 210 via a data access service 224. In some cases, the data consumer applications 230a-n may request payment transaction information from the payment data repository 210 via one or ore API function calls, such that upon calling of an API function by the data consumer application 230a, the data access service 224 returns the requested information from the payment data repository 210 to the calling data consumer application 230a.

At 335, a reporting service 226 of the payment data management system 220 may monitor or otherwise manage operation of the data access service 224 and/or the transaction pipeline service 222 to determine communications metrics regarding operation of the transaction pipeline service 222 and the data access service 224. For example, the reporting service 226 may monitor throughput of payment transaction information from each payment service 240a-n and/or the batch payment service 250a-n and to a corresponding regional payment data repository 210. The reporting service 226 may further determine metrics regarding operation of reach regional data store of the payment data repository 210 within the external computing environment (e.g., cloud computing environment), and/or a copy of the payment data repository to identify metrics regarding communications from each payment service, batch payment service and/or data consumer application, such as to determine whether one or more regional data stores are overloaded or otherwise operating improperly and communicating a message or an alert to initiate remedial actions. For example, an alert sent by the reporting service may initiate, automatically or with additional inputs, maintenance on a regional payment data repository and/or rerouting of communications from one or more regional payment data repository to a different regional payment data repository or to a mirrored copy of the payment data repository within the enterprise computing network. The reporting service 226 may further generate reports and automatically display the reports and/or alerts on a display of a remote computing device.

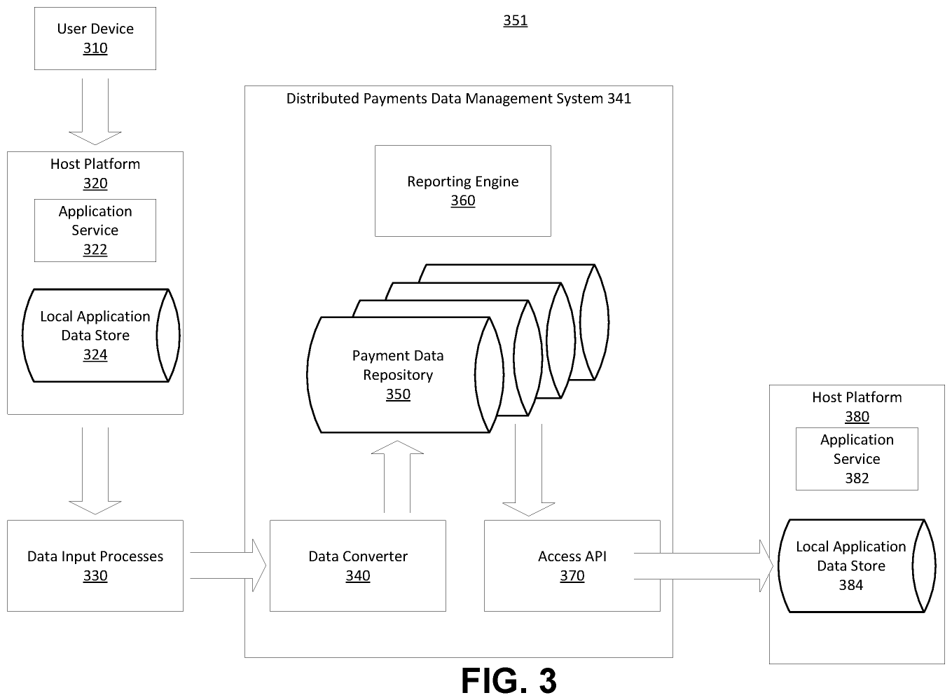

FIG. 3 show an illustrative use of the continuously available distributed payments transaction computing system 351, in accordance with one or more example arrangements. The system 351 may include a user device 310, one or more host platforms 320 and 380, a distributed payments data management system 341, and one or more computing devices facilitating operation of one or more data input processes 330. In the illustrative example, a user of the user device 310 may initiate a payment transaction via a payment service offered by the enterprise organization, such as by invoking an operation via an application service 322 on the host platform 320, where certain aspects of the payment transaction may utilize information stored on a local application data store 324. For example, the payment transaction may be an electronic payment on a loan, a credit card payment transaction, an electronic purchase transaction, a person to person payment transaction, and/or the like. The application service 322 may communicate the payment transaction information to a central data repository, for example, to complete the payment transaction. The application service 322 may communicate the payment transaction information via a data input process 330 to the distributed payments data management system 341. In some cases, the data input processes 330 may store the payment transaction information into a regionalized payment data repository 350. In some cases, the data input processes 330 may communicate to a data converter 340 to, for example, convert payment transaction information from a legacy format of the particular application service 322, to a standardized payment transaction data format utilized in the payment data repository 350.

The host platform 380 may utilize the payment transaction information in the payments data repository 350 to complete the payment transaction, such as by the application service 382 utilizing further information stored in the local application data store 384. For example, the host platform 380 may be another host platform running a person to person payment application, where the receiving host platform completes a person to person payment transaction initiated by the user device 310, such as by accessing the payment transaction information stored in the payment data repository 350 via API function calls, which returns data in the standardized data format, which may then be converted to a format utilized by the application service 382. In some cases, the reporting engine 360 may monitor operation of the distributed payments data management system 341, such as by monitoring communications and operations of the regionalized data store. The reporting engine 360 may initiate an alert based on a data read error, a data write error, a data replication error, a communication error, and/or the like. In some cases, the reporting engine 360 may automatically initiate an error reaction based on certain errors, such as by rerouting communications to another regional data store to ensure data is continuously accessible, even when a particular regional instance of the payment data repository is currently unavailable or access is compromised.

An online data store, such as a regionalized payment ODS improves access to payment data by sourcing consumer payments transaction information, in near real time, to a highly available and scalable cloud hosted data store. The payment ODS may be implemented with a standardized payments data model to enhance real-time data availability with real time data provisioning. Additionally, by decoupling transaction processing from transaction enquiry, optimal processing performance may be ensured. Additionally, by centralizing the payment ODS in a regionalized data store, data duplication is reduced, which also reduces hardware and communication network requirements to acquire, provision and consume data. Additionally, the centralized and regionalized payments data store improves data quality and data consistency by reducing data replication errors, which improves data monitoring and alerting with coverage across products. Such monitoring may further allow for better identification of improper data use and fraud activities.

By hosting the payment ODS in an external environment, such as a cloud computing environment, managing the data repository may be performed as a fully managed database service. The distributed payment ODS may be geographically replicated, and therefore may be available for read and write access across geographical regions. The cloud computing environment allows for automatic scaling based on loading information for data ingestion activities and/or data consumption activities. Additionally, providing the payments transaction information in geo-replicated data stores allows easier support for further application development, particularly with cloud-based applications. Additional advantages of a cloud-based environment include high availability with minimal to no downtime, no data loss, and built-in active architecture with multi-master write. The cloud environment provides flexibility where, for example, a database schema may be easily adaptable for change, with no vendor-based lock-in of the solution. Cloud computing environments allow high security, where data access is done via application programming interfaces using managed identity for client applications, where data encryption is available for stored data and data communications. Cloud computing environments also offer high performance for data reading and writing and are easily managed by a centralized computing infrastructure.

Examples of payment transaction application include immediate transfer applications (e.g., account to account payment transactions), electronic wire transfer payment transaction application, a person to person payment transaction application, a digital disbursement payment transaction application, a real time payment transfer application (e.g., bank as a biller), a scheduled electronic payment transaction transfer application, a bill-pay payment transaction application, and/or the like.

In some cases, access to multi-regional electronic payment information may be improved through use of the payment ODS, such as by providing consumer payment transaction information, in real time or near real-time, via a highly available and scalable remote-hosted (e.g., cloud-hosted) datastore. Additionally, the payment ODS may provide a standard payments data model that enhances data availability by providing real time data provisioning capabilities. Here, transaction processing is decoupled from transaction inquiries to improve processing performance of computing systems accessing the same payments transaction information and/or storing the payments transaction information. Additionally, data duplication among multiple and parallel data stores associated with each different payment system. Because additional computing infrastructure has been necessary to facilitate new payment processes and services, the multi-regional payment ODS reduces costs to implement, acquire, provision computing hardware to process and/or consume data associated with the payment transactions. Further, the payment ODS system improves quality and consistency of data and allows for improved monitoring and alerting across technologies including involving the payment processes and services. Data center communications may be monitored to ensure cross data center and/or cross regional resiliency to guarantee that the database remains highly available for resilient read/write access regardless of any site, region or datacenter outage. The Payment ODS remains active across regions and is replicated among nodes, where data replication between the multiple sites and/or regions may be performed in an active-active mode. High local availability and/or failover capability may be provided for each region or data center, with strong data replication consistency (immediate consistency) across regions. Read/write performance may be monitored with respect to a threshold, where deviations from that threshold (e.g., read/inquiry performance at 2000 tps average/5000 tps peak volume and writes at 1000 tps/2000 tps peak) for the entire payment data store and/or a regional data store may initiate a response automatically. Throughput may be monitored based on a defined thresholds, such as on a batch level (e.g., 50 GB data per batch) or read level (e.g., 200 GB of data reads) per day. may be monitored

In some cases, the ODS data store may include a history of payment transactions (e.g., a 1 year history, 2 year history, 5 year history, and the like). A data model may be expanded or otherwise changed as necessary, where legacy products may have up to 2000 data fields, and where a payment data standard may include about 5000 data fields. Operational performance of the payment ODS may include millions of reads (e.g., 50 million, 60 million, 100 million, and the like) and millions of writes/per day (e.g., 10 million, 20 million, 50 million, and the like).

Data monitoring and/or alerting functionality may include monitoring and alerting certain metrics of the system during operation. For example, data ingestion may be monitored to identify an ingestion lag from the time a transaction is processed/executed by an application of record and information of that transaction is made available in the payment data repository for query. Additionally, data consistency metrics may be monitored, such as a zero data loss metric (e.g., no data loss due to node failure, availability zone failure or region/data center failure), strong replication consistence metric (e.g., immediate data consistency across replicas of the data store to ensure consistent data views when data is queried across different regions and/or geographical locations), and the like. Performance metrics may include throughput metrics (e.g., 2000 transactions per second for writes/5000 transactions per second for reads), where performance metrics may be analyzed under minimal loading conditions and full load conditions to determine any degradation based on changing consistency levels and may include calculating transformation lag times when performing complicated data transformations.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of being entirely hardware, entirely software, entirely firmware, or a combination of software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a host computing device hosting at least one first service initiating an electronic payment transaction;
a distributed payment repository platform, comprising:
a processor; and
non-transitory memory storing instructions that, when executed by the processor, cause the distributed payment repository platform to:
receive, from the host computing device, payment transaction information corresponding to the electronic payment transaction;
convert the payment transaction from a first data format to a standardized data format;
store the payment transaction in a cloud-based data repository;
receive, from a second host computing device, a request for the payment transaction information;
communicate, to the second host computing device, the payment transaction information; and
the second host computing device comprising at least one second service, wherein the second host computing device, based on receive payment transaction information, completes the electronic transaction.

2. The system of claim 1, wherein the at least one first service and the at least one second service comprises one or more of a person to person payment service, an installment payment service, or a wire transfer payment service.

3. The system of claim 2, wherein the at least one first service comprises the first data format and the at least one second service comprises a second data format different from the first data format.

4. The system of claim 2, wherein the standardized data format is with an international standard data format.

5. The system of claim 1, wherein the instructions further cause the distributed payment repository platform to replicate the cloud-based data repository in multiple regional data stores.

6. The system of claim 5, wherein at least one data store of the multiple regional data stores comprises a second cloud-based data store.

7. The system of claim 6, wherein at least one data store of the multiple regional data stores comprises a locally hosted data store.

8. A method comprising:
receiving, from a host computing device providing at least one payment service, payment transaction information corresponding to an electronic payment transaction;
converting the payment transaction from a first data format to a standardized data format;
storing the payment transaction in a cloud-based data repository;
receiving, from a second host computing device, a request for the payment transaction information;
communicating, to the second host computing device, the payment transaction information; and
completing, by the second host computing device and based on received payment transaction information, the electronic transaction.

9. The method of claim 8, wherein the at least one payment service comprises one or more of a person to person payment service, an installment payment service, or a wire transfer payment service.

10. The method of claim 8, wherein the at least one payment service comprises the first data format and the second host supports second data format different from the first data format.

11. The method of claim 8, wherein the standardized data format is an international standard data format.

12. The method of claim 8, further comprising causing replication the cloud-based data repository in multiple regional data stores.

13. The method of claim 12, wherein at least one data store of the multiple regional data stores comprises a second cloud-based data store.

14. The method of claim 13, wherein at least one data store of the multiple regional data stores comprises a locally hosted data store.

15. Non-transitory computer readable media storing instructions that, when executed by a processor, cause a distributed payment repository platform to:
receive, from a host computing device, payment transaction information corresponding to an electronic payment transaction;
convert the payment transaction from a first data format to a standardized data format;
store the payment transaction in a cloud-based data repository;
receive, from a second host computing device, a request for the payment transaction information; and
initiate, by the second host computing device, completion of the payment transaction information based on returning the payment transaction information.

16. The non-transitory computer readable media of claim 15, wherein a first service provided by the first host computing device and a second service provided by the second host computing device comprises one or more of a person to person payment service, an installment payment service, or a wire transfer payment service.

17. The non-transitory computer readable media of claim 15, wherein a first payment service provided by the first host computing device comprises the first data format and a second payment service provided by the second host computing device comprises a second data format different from the first data format.

18. The non-transitory computer readable media of claim 15, wherein the instructions further cause the distributed payment repository platform to replicate the cloud-based data repository in multiple regional data stores.

19. The non-transitory computer readable media of claim 18, wherein at least one data store of the multiple regional data stores comprises a second cloud-based data store.

20. The non-transitory computer readable media of claim 18, wherein at least one data store of the multiple regional data stores comprises a locally hosted data store.
